(19) United States
(12) Patent Application Publication
(10) Pub. No.: US 2020/0017209 A1
(43) Pub. Date: Jan. 16, 2020

(54) MODULAR ROBOTIC SYSTEM

(71) Applicants: Alberto Lacaze, Gaithersburg, MD (US); Karl Murphy, Gaithersburg, MD (US)

(72) Inventors: Alberto Lacaze, Gaithersburg, MD (US); Karl Murphy, Gaithersburg, MD (US)

(21) Appl. No.: 16/035,134

(22) Filed: Jul. 13, 2018

(51) Int. Cl. B64C 37/00; B64C 39/02; B64D 7/00; B64D 27/26; B60F 5/00; B60F 5/02; B62D 63/02; B63G 8/00

(52) U.S. Cl. CPC B64C 37/00; B64C 39/024; B64D 7/00; B64D 27/26; B60F 5/00; B60F 5/02; B63G 2008/004; B63G 8/001; B64C 2201/042; B64C 2211/00; B64C 2201/127; B64C 2201/145; B64D 2027/262; B62D 63/025

(57) ABSTRACT

The modular robotic system disclosed herein may comprise a central body that houses various essential components, a plurality of propulsion arms, and a plurality of quick-detach mechanisms. The combination is designed to be assembled, have individual components replaced, and be converted from one embodiment to another without the use of any tools. The plurality of propulsion arms may be designed for any mission-specific task or may be designed to perform multiple tasks, such as ground or aerial movement, depending on their orientation. The system is also designed to be quickly disassembled for storage and carrying in a backpack.

### PRIORITY NOTICE

The present application is a non-provisional application and makes no claims of priority under 35 U.S.C. § 119(e) to any U.S. Provisional patent applications.

### TECHNICAL FIELD OF THE INVENTION

The present invention relates in general to robotic systems, and, more specifically, to a modular robotic system comprising, at least, a central body that houses various essential components, a plurality of propulsion arms, and a plurality of quick-detach mechanisms.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

An un-crewed vehicle, or unmanned vehicle, is a vehicle that may operate without a person aboard. Such vehicles may comprise onboard power, communications, and propulsion subsystems that may be controlled remotely by a human pilot, and may be designed as unmanned aerial vehicles (UAVs), as unmanned ground vehicles (UGVs), or remotely-operated underwater vehicles (ROVs). Such vehicles may be collectively known as “drones” and are in common use in various military and commercial applications, including delivery of packages to consumers, delivery of assets to soldiers in combat, and delivery or ordinance against hostile targets. Though the costs of such vehicles and their commercial components is rapidly decreasing because of the hobby market, significant costs still remain for military-specific components such as tactical radios and visual or infrared sensors. It is not uncommon in the current market for the positioning, communications, and sensing components of military-grade drones to be several orders of magnitude more expensive than the propulsion system and drone frame.

Inherent to the significant costs of military drones is the need to purchase a single drone for each mission-specific task that must be performed, including a single set of military-grade subsystems for each drone. Such drones are made available with a unibody frame or a multi-component frame designed for the specific task, and the subsystems for such drones may be integrated into the frame or have the frame designed around their form-factor. Repair of such drones may be effected by replacing damaged components of the frame or damaged subsystems, and the mission capabilities of the drone may be altered within limits by replacing some of the components. Such drones, though, may not be capable of performing significantly varied missions, for example where an aerial drone (UAV) may be required to perform a task suited to a surface drone (UGV). Additionally, where a drone is damaged beyond reasonable repair, the cost of continuing to perform the task of that drone is to purchase a second complete unit.

It is known to have a drone frame in a variety of form factors, which may be specifically designed to achieve a plurality of mission-specific tasks. By way of examples, a drone frame may be required to perform aerial maneuvers and reconnaissance, and may be designed to incorporate the subsystems needed to sustain powered flight and video recording. A second drone frame may be required to perform explosives disposal, and may incorporate the subsystems needed for ground maneuvering and delicate handling of materials.

It is known to have a plurality of electronic drone components, which may serve specific essential tasks within a drone system. A drone receiver, which may be a radio receiver and which may be paired to a remote transmitter, may receive control commands from a remote operator of the drone and may output signals to the various subsystems within the drone. A control module may receive signals from a plurality of components within the drone and may regulate the performance of the drone subsystems to achieve specific movements and functions. An electronic speed controller (ESC) may receive signals from the control module to control the speed and direction of the various motors within the drone itself. The motors may drive a plurality of means for locomotion, such as wheels, tracks, or propellers. A battery, which may be removable or rechargeable, may provide power to the various components of the drone system. While a drone system may comprise additional subsystems, such components are essential to its basic functioning.

There is a need in the art for modular robotic system comprising, at least, a central body that houses various essential components, a plurality of propulsion arms, and a plurality of quick-detach mechanisms. Such a system may reduce the cost of acquiring military-grade drones by isolating the costly components into a central location while allowing for the cost-effective-replacement of commonly-damaged components. Such a system may further provide for a drone system capable of performing multiple, various mission-specific tasks by the replacement of the plurality of propulsion arms with those most suited for each task. The plurality of propulsion arms may be further designed to articulate or be rearranged so that the propulsion arms in a single orientation may be best suited to a specific task, while the same arms in a second orientation may be best suited to a different task. Such a system may be further designed for compact storage and carrying in a backpack by a single user.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a modular robotic system comprising, at least, a central body that houses various essential components, a plurality of propulsion arms, and a plurality of quick-detach mechanisms.

It is an objective of the present invention to provide a modular robotic system that may be assembled without the use of any tools.

It is another objective of the present invention to provide a modular robotic system that may have individual components replaced without the use of any tools.

It is another objective of the present invention to provide a modular robotic system that may be converted from one embodiment to another without the use of any tools.

It is another objective of the present invention to provide a modular robotic system that may comprise a plurality of propulsion arms designed for ground movement.

It is another objective of the present invention to provide a modular robotic system that may comprise a plurality of propulsion arms designed for aerial movement.

It is another objective of the present invention to provide a modular robotic system that may comprise a plurality of propulsion arms designed for ground and aerial movement.

It is another objective of the present invention to provide a modular robotic system that may be adapted for use in a wide spectrum of mission-specific tasks.

It is another objective of the present invention to provide a modular robotic system that may be disassembled, stored, and carried in a backpack.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an exemplary central body of a modular robotic system.

FIG. 2 illustrates an exemplary propulsion arm of a modular robotic system.

FIG. 3 illustrates an exemplary propulsion arm of a modular robotic system.

FIG. 4 illustrates a first embodiment of a modular robotic system in a first orientation.

FIG. 5 illustrates a second embodiment of a modular robotic system in a first orientation.

FIG. 6 illustrates a first embodiment of a modular robotic system in a second orientation.

FIG. 7 illustrates a second embodiment of a modular robotic system in a second orientation.

### DETAILED DESCRIPTION OF THE INVENTION

Certain terminology is used in the following description for reference only and is not limiting. Unless specifically set forth herein, the terms “a,” “an,” and “the” are not limited to one element, but instead should be read as meaning “at least one.”

The present invention relates in general to robotic systems, and, more specifically, to a modular robotic system comprising, at least, a central body that houses various essential components, a plurality of propulsion arms, and a plurality of quick-detach mechanisms. As contemplated by the present disclosure, the modular robotic system separates the expensive electronics relevant to the control of the vehicle that allows for exchangeable propulsion mechanism. This exchangeable propulsion mechanism can easily be applied in the field to quickly optimize the propulsion system to the desired payload, while still using the same core components. The proposed physical prototypes will allow the same core electronics/sensing/localization to be interchangeable with the means of propulsion, thus allowing for air, ground, air/ground, and fixed wing configurations, all in the same backpackable platform.

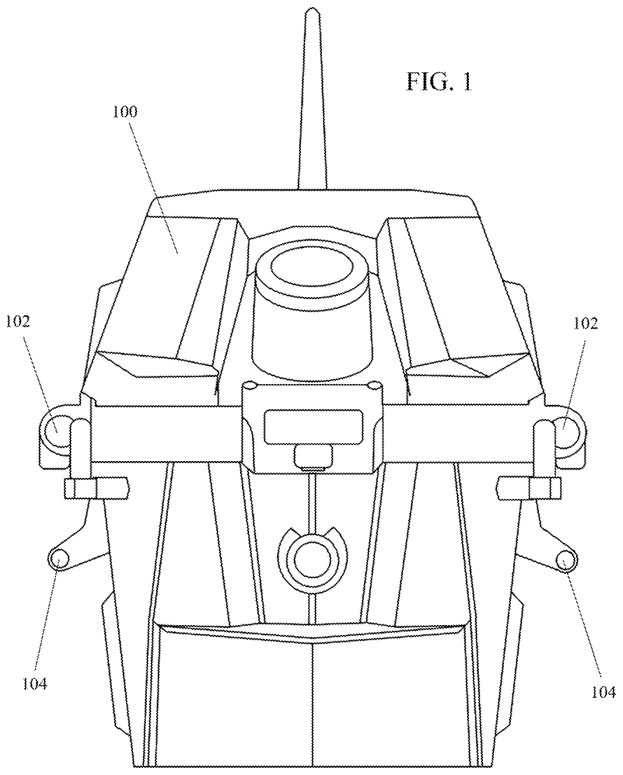

FIG. 1 illustrates an exemplary central body of a modular robotic system identifying a central body 100, a plurality of propulsion arm receivers 102, and a plurality of body articulation points 104. The central body 100 may contain a computer, motor controller, a plurality of cameras, laser detection and ranging (LADAR), radio detection and ranging (RADAR), global positioning system (GPS), mechanical and electrical interfaces, controller area network (CAN bus), and a power source.

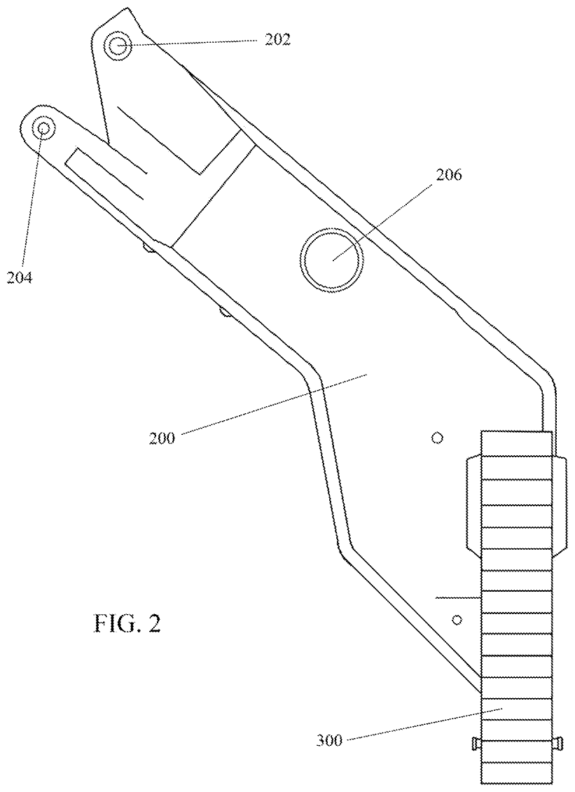

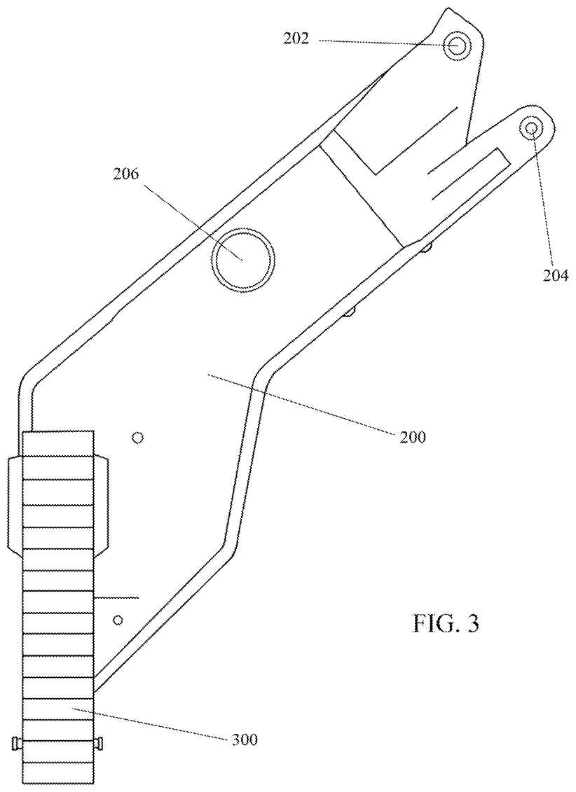

FIGS. 2 and 3 illustrate an exemplary propulsion arm of a modular robotic system identifying a propulsion arm 200, central body receiver 202, arm articulation point 204, motor mount receiver 206, and foot pad 300. The propulsion arm 200 may contain a plurality of aerial motors, a plurality of ground motors, CAN bus, and mechanical and electrical interfaces.

The propulsion arm 200 is attached to the central body 100 via a quick-detach mechanism, and may be removed or installed without the use of tools. The plurality of propulsion arm receivers 102 interface with the plurality of central body receivers 202 to permit the articulation of the plurality of propulsion arms 200 from a ground orientation to a flight orientation. The plurality of body articulation points 104 interface with the plurality of arm articulation points 204 to drive the articulation of the plurality of propulsion arms 200 from a ground orientation to a flight orientation. In one embodiment of the present device, an extension arm may connect the plurality of body articulation points 104 with the plurality of arm articulation points 204. The extension of the extension arm may push the plurality of propulsion arms 200 into a flight orientation while the retraction of the extension arm may pull the plurality of propulsion arms 200 into a ground orientation.

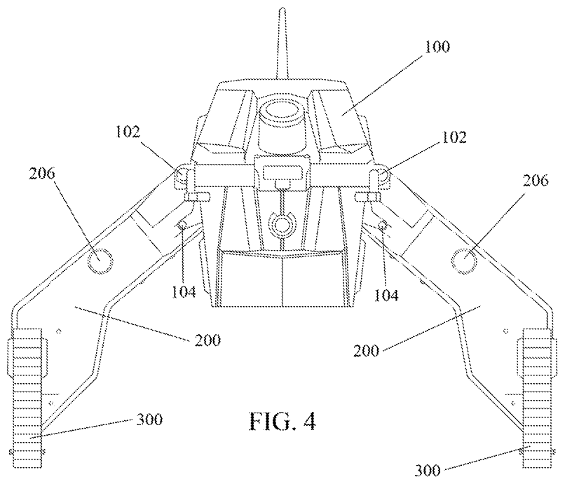

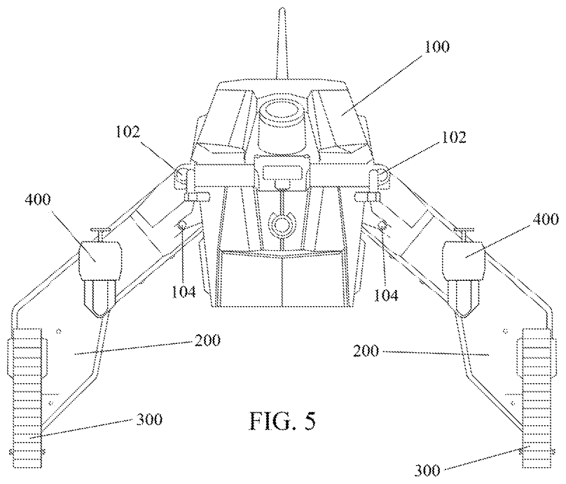

FIGS. 4 and 5 illustrate a modular robotic system in a ground orientation identifying a central body 100, a plurality of propulsion arm receivers 102, and a plurality of body articulation points 104, a plurality of propulsion arms 200, a plurality of motor mount receivers 206, a plurality of foot pads 300, and a plurality of motors 400. The plurality of motors 400 are attached via the plurality of motor mount receivers 206 to the plurality of propulsion arms 200. The plurality of motors 400 may articulate relative to the plurality of propulsion arms 200 to ensure that the plurality of motors 400 remain in an upright position when the plurality of propulsion arms 200 articulate from the ground orientation to the flight orientation.

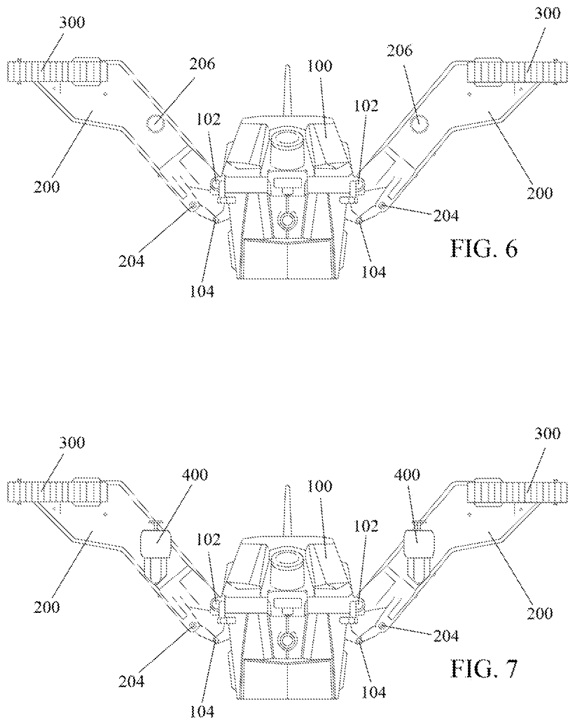

FIGS. 6 and 7 illustrate a modular robotic system in a flight orientation identifying a central body 100, a plurality of propulsion arm receivers 102, and a plurality of body articulation points 104, a plurality of propulsion arms 200, a plurality of arm articulation points 204, a plurality of motor mount receivers 206, a plurality of foot pads 300, and a plurality of motors 400.

The plurality of propulsion arms 200 are interchangeable and may be articulated from the ground orientation to the flight orientation so as to protect the propellers in flight mode, provide a full 360-degree field of view for an underslung camera when in aerial mode, and to alter the center of gravity (CG) relative to the center of mass (CM) and the center of propulsion (CP). The change of CG relative to CM and CP converts the system from a slow and stable intelligence, surveillance, and reconnaissance (ISR) platform to a fast moving craft for escape or movement to target.

The plurality of propulsion arms 200 may be designed for a plurality of mission-specific tasks, such as heavy lift and high endurance. Providing both capabilities within a single system would result in a heavy combination, so these capabilities may be delivered as exchangeable attachments for the same platform. For heavy lift, larger motors and electronic speed controllers are necessary. The larger motors will drain the battery faster, reducing the flight time but allowing the platform to lift a higher weight.

For high endurance, large propellers are necessary. As a rule of thumb, efficiency and flight time are directly proportional to the blade diameter. The same battery will fly the same payload twice as long with propellers that are twice as long. A longer leg that can house a longer set of propellers at twice the diameter will fly the system approximately twice as long as the standard orientation. Another set of legs may include fixed wings to further increase that flight time.

The modular robotic system may further comprise significant functionality, including autonomous mobility (obstacle avoidance) both in the air and on the ground, and situational awareness tools including 2D and 3D mapping. The system may also be weaponized by adding hardpoints to the central body 100 or propulsion arms 200.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

I claim:

1. A modular robotic system, comprising:
a central body;
a plurality of electronic drone components;
a power source
a plurality of propulsion arms; and
a plurality of quick-detach mechanisms;
wherein said plurality of electronic drone components is contained within said central body; and
wherein said plurality of propulsion arms are connected to said central body via said plurality of quick-detach mechanisms.

2. The invention of claim 1, further comprising:
a plurality of means for articulation; and
a plurality of motors;
wherein said plurality of means for articulation cause said plurality of propulsion arms to articulate relative to said central body;
wherein said plurality of motors are attached to said plurality of propulsion arms; and
wherein said plurality of motors articulate relative to said plurality of propulsion arms such that said plurality of motors remain in an upright orientation.

3. The invention of claim 2,
wherein said central body further comprises a plurality of propulsion arm receivers and a plurality of body articulation points;
wherein said plurality of propulsion arms further comprise a plurality of central body receivers, a plurality of arm articulation points, a plurality of motor mount receivers, and plurality of foot pads;
wherein said plurality of central body receivers on said plurality of propulsion arms are connected to said plurality of propulsion arm receivers on said central body by said plurality of quick-detach mechanisms; and
wherein said plurality of arm articulation points on said plurality of propulsion arms are connected to said plurality of body articulation points on said central body by said plurality of means for articulation.

4. The invention of claim 3,
wherein said plurality of electronic drone components comprise a drone receiver, a control module, and an electronic speed controller.

5. The invention of claim 4, further comprising:
a plurality of cameras;
wherein said plurality of cameras are attached to said central body.

6. The invention of claim 4, further comprising:
a laser detection and ranging system;
wherein said laser detection and ranging system allows for autonomous mobility of said modular robotic system.

7. The invention of claim 4, further comprising:
a radio detection and ranging system;
wherein said radio detection and ranging system allows for autonomous mobility of said modular robotic system.

8. The invention of claim 4, further comprising:
a global positioning system.

9. The invention of claim 4, further comprising:
a controller area network.

10. The invention of claim 4, further comprising:
a plurality of weapon hardpoints.

11. The invention of claim 4,
wherein said power source is located within said central body.

12. The invention of claim 4,
wherein said power source is located within said plurality of propulsion arms.

13. The invention of claim 4,
wherein said plurality of propulsion arms provide aerial propulsion.

14. The invention of claim 4,
wherein said plurality of propulsion arms provide ground propulsion.

15. The invention of claim 4,
wherein said plurality of propulsion arms provide water propulsion.

16. The invention of claim 4,
wherein said plurality of propulsion arms provide underwater propulsion.

17. The invention of claim 4,
wherein articulation of said propulsion arms is used to change the center of gravity of the modular robotic system so as to produce varying flight characteristics.
